(19) United States
(12) Patent Application Publication
(10) Pub. No.: US 2004/0145536 A1
(43) Pub. Date: Jul. 29, 2004

(54) Hand-held device having a window and a flexible, retractable-detractable display for permitting an image to be viewed from either the window or the display

(76) Inventors: Thomas M. Stephany, Churchville, NY (US); Richard W. Wien, Pittsford, NY (US); James G. Chase, Fendalton (NZ)

Correspondence Address: Thomas H. Close, Patent Legal Staff, Eastman Kodak Company, 343 State Street, Rochester, NY, 14650-2201, US

(21) Appl. No.: 10/353,410

(22) Filed: Jan. 29, 2003

(51) Int. Cl. G09G 5/00

(52) U.S. Cl. 345/3.1

(57) ABSTRACT

A hand-held device having a window for permitting an image to be viewed, the hand-held device includes a housing: and a display having two display portions each of which display images, which display may be extracted from or retracted into the housing; wherein, when the display is retracted, one of the two displays is displayed through the window, and when the display is extracted, the two portions of the display displays either one image on the two portions or displays two individual images on the two portions.

### FIELD OF THE INVENTION

The invention relates generally to the field of hand-held devices and, more particularly, to such devices having a retractable and extractable flexible display which, when retracted, displays through a window of the hand-held device. When the display is extracted, two portions of the display displays either one image on the two portions or displays two individual images on the two portions.

### BACKGROUND OF THE INVENTION

Flexible displays are currently available for permitting viewing of images thereon. Such displays are available from Philips Research in Eindhoven, Netherlands. Such flexible displays are also in prototype “pen communicators” from Universal Display Corp. These “pen communicators” include a small cylindrical housing into which the display is retracted or from which the flexible display is extracted for viewing images thereon.

Although these currently available technologies are satisfactory for rudimentary purposes, they are not acceptable for realizing consumer acceptance. Therefore, a need exists for providing improved flexible displays that are acceptable for widespread consumer adoption.

### SUMMARY OF THE INVENTION

The present invention is directed to overcoming one or more of the problems set forth above. Briefly summarized, according to one aspect of the present invention, the present invention resides in a hand-held device having a window for permitting an image to be viewed, the hand-held device comprising: a housing; and a display having two display portions each of which display images, which display may be extracted from or retracted into the housing; wherein, when the display is retracted, one of the two displays is displayed through the window, and when the display is extracted, the two portions of the display displays either one image on the two portions or displays two individual images on the two portions.

These and other aspects, objects, features and advantages of the present invention will be more clearly understood and appreciated from a review of the following detailed description of the preferred embodiments and appended claims, and by reference to the accompanying drawings.

### ADVANTAGEOUS EFFECT OF THE INVENTION

The present invention has the advantage of large screen viewing in a relatively small device. It also includes the ability of viewing the flexible display when retracted into the device.

### BRIEF DESCRIPTION OF THE DRAWINGS

FIG. 1 is a front view of the hand-held device of the present invention;

FIG. 2 is a front view of the device of the present invention with the display extracted;

FIG. 3 is a front view of the device of the present invention with the display extracted illustrating a picture-in-picture; and

FIG. 4 is front view of the device of the present invention illustrating a support for the extracted display.

### DETAILED DESCRIPTION OF THE INVENTION

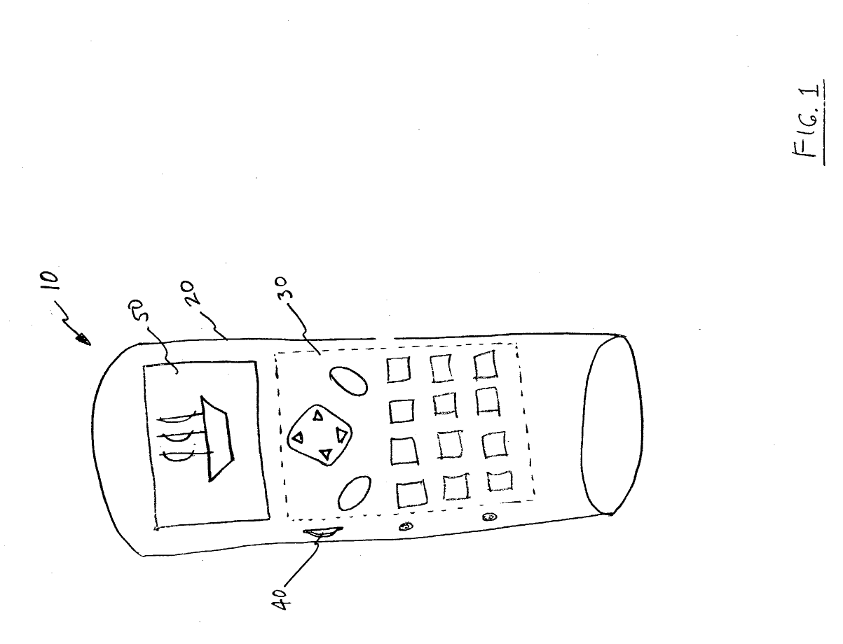

Referring to FIG. 1, there is shown the hand-held device of the device, preferably a palm computer 10. The computer 10 includes a housing 20 into which are a plurality of computer chips (not shown) are positioned. These chips are obviously for permitting well known computing functions. An input device 30, preferably a key pad, is disposed on the housing for inputting data, and a power switch 40 is also on the housing for energizing the device. The computer 10 also includes a low-resolution display 50 for permitting viewing of images thereon.

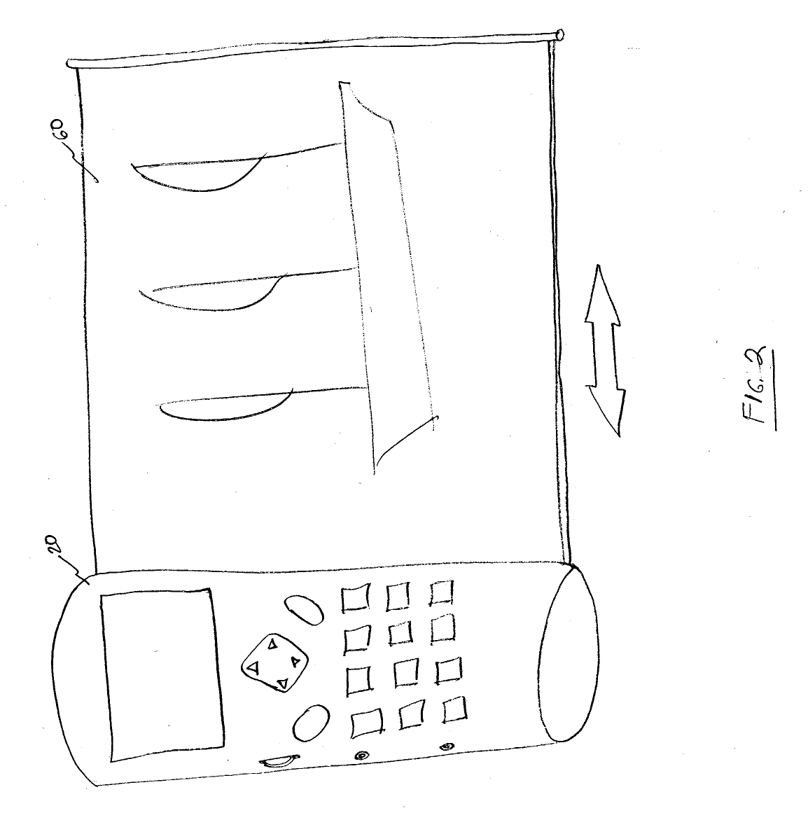

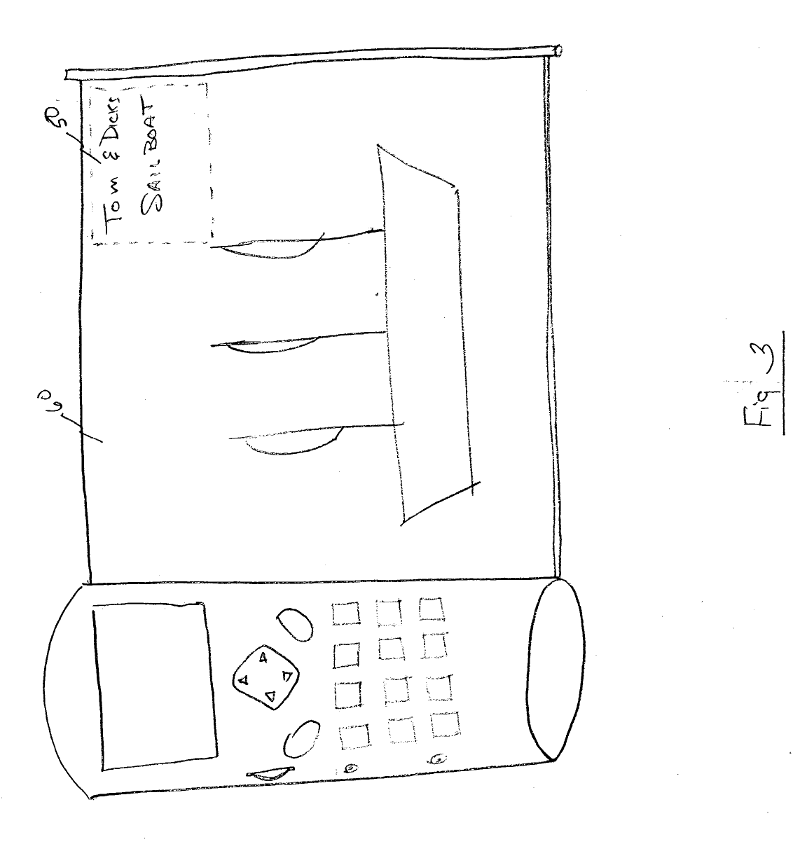

Referring next to FIG. 2, a flexible, high-resolution display 60 is shown extracted from the housing 20. Such displays are well known and further disclosure is not required herein. The display can be either LCD or OLED or partitioned into regions of LCD and OLED. It may be readily apparent that a user can grasp the edge of the display 60 and pull it from the housing 20 (hereafter referred to as its extracted state) for permitting viewing in greater resolution. Additionally, resolution is defined as the total number of pixels residing within the defined perimeter of the display. It is instructive to note that the object shown in display 50 (noted in FIG. 1) can be displayed in significantly higher resolution in the display 60. It should also be noted that the low-resolution display 50 is a sub-portion of display 60 so that, when the display 60 is extracted, the low-resolution may be displayed in a portion of the high-resolution display 60. Alternatively when the display 60 is retracted, pictorial information is displayed only upon display 50. This low-resolution display may also be disposed so that display 50 can show information which is part of or separate from display 60. In other words when you send information to display 60, you can send signals representing an entire screen. Alternatively, you can send signals that can represent two screens of information, one displayed on screen 50, and the other displayed on screen 60, as shown in FIG. 3.

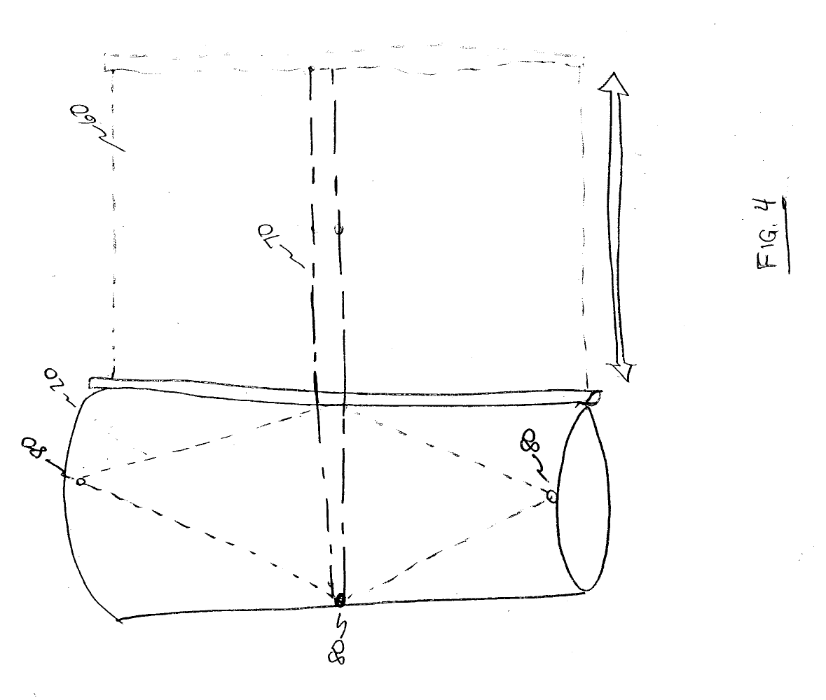

Referring now to FIG. 4, a support mechanism 70 is first shown in retracted mode (shown in dashed lines) within the housing 20. The support mechanism 70 can be extracted by grasping its edge and pulling it therefrom into its extended state (shown in double-dashed lines). When extracted, the support mechanism 70 forms a support for the display 60.

It is instructive to note that, although the display is shown extracted for persons of right-hand orientation, the display can be retracted from either side so that it accommodates persons of left-hand orientation. Additionally, it should be noted that the support mechanism 70, when retracted, can be removed from the housing 20 by removing pivot pins 80 for additional convenience. It is also pointed out that the display 60 can be a touch screen display so that data can be input by touching.

The invention has been described with reference to a preferred embodiment. However, it will be appreciated that variations and modifications can be effected by a person of ordinary skill in the art without departing from the scope of the invention.

### PARTS LIST

10 computer

20 housing

30 input device

40 power switch

50 low-resolution display

60 flexible, high-resolution display

70 support mechanism

80 pivot pins

What is claimed is:

1. A hand-held device having a window for permitting an image to be viewed, the hand-held device comprising:
(a) a housing:
(b) a display having two display portions each of which display images, which display may be extracted from or retracted into the housing; wherein, when the display is retracted, one of the two displays is displayed through the window, and when the display is extracted, the two portions of the display displays either one image on the two portions or displays two individual images on the two portions.

2. The hand-held device as in claim 1, wherein the two portions are one portion of coatable LCD and one portion of OLED.

3. The hand-held device as in claim 1, wherein the two portions are all OLED.

4. The hand-held device as in claim 1, wherein the two portions are all coated LCD.

5. The hand-held device as in claim 1, wherein only one of the two portions of the displayed is energized at a given time.

6. The hand-held device as in claim 1, wherein the two portions of the display distinct images.

7. The hand-held device as in claim 6, wherein one of the distinct images in one display is transferred to the image in the other display.

8. The hand-held device as in claim 1, wherein the display is extracted from and retracted into either of two sides of the housing.

9. The hand-held device as in claim 1 further comprising a support which is extracted from and retracted into the housing and onto which the display may rest for providing a support for the display.

10. The hand-held device as in claim 1 further comprising an attachable support which is attached to the housing and onto which the display may rest for providing a support for the display.

11. The hand-held device as in claim 1, wherein the display includes a mechanism to input data via the display.

12. A hand-held device having a window for permitting a images to be viewed, the hand-held device comprising:
(a) a housing:
(b) a display which display may be extracted from or retracted into the housing; wherein, when the display is retracted, images may be through the window, and when the display is extracted, images may also be displayed thereon.

13. The hand-held device as in claim 12, wherein the display is either coatable LCD or of OLED.

14. The hand-held device as in claim 12 further comprising a support which is extracted from and retracted into the housing and onto which the display may rest for providing a support for the display.

15. The hand-held device as in claim 12 further comprising an attachable support which is attached to the housing and onto which the display may rest for providing a support for the display.

16. The hand-held device as in claim 12, wherein the display includes a mechanism to input data via the display.
